(19) United States
(12) Patent Application Publication
(10) Pub. No.: US 2026/0230819 A1
(43) Pub. Date: Aug. 6, 2026

(54) GENERATING A SECURITY CONTEXT FOR USER EQUIPMENT (UE) TRUSTED NON-3GPP ACCESS POINT (TNAP) MOBILITY

(71) Applicant: LENOVO (SINGAPORE) PTE. LTD., Singapore (SG)

(72) Inventors: Sheeba Backia Mary BASKARAN, Friedrichsdorf (DE); Andreas KUNZ, Ladenburg (DE)

(21) Appl. No.: 19/152,583

(22) PCT Filed: Feb. 1, 2024
(86) PCT No.: PCT/IB2024/050948

§ 371 Date: Jul. 31, 2025

Related U.S. Application Data
(60) Provisional application No. 63/482,717, filed on Feb. 1, 2023.

(51) Int. Cl. H04W 12/069

(52) U.S. Cl. CPC H04W 12/069

(57) ABSTRACT

Various aspects of the present disclosure relate to UE TNAP Mobility. For example, the technology can provide UE TNAP Mobility authentication and security establishment procedures, such as procedures that utilize new input parameters and security key refreshes during the authentication and security establishment procedures when a UE moves from a source TNAP to a target TNAP.

### CROSS-REFERENCE TO RELATED APPLICATIONS

This application is a national phase entry of International Application No. PCT/IB2024/050948, filed Feb. 1, 2024, which claims priority to U.S. Provisional Patent Application No. 63/482,717, filed on Feb. 1, 2023, entitled GENERATING A SECURITY CONTEXT FOR USER EQUIPMENT (UE) TRUSTED NON-3GPP ACCESS POINT (TNAP) MOBILITY, which are hereby incorporated by reference in their entirety.

### TECHNICAL FIELD

The present disclosure relates to wireless communications, and more specifically to Trusted Non-3GPP Access Point (TNAP) Mobility.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The 5G network supports authentication for trusted non-3GPP access by UEs, where a UE connects (e.g., registers) to a 5G core network via a trusted Non-3GPP Access Network (TNAN). For example, as stated in Rel.17, when a UE moves from a source TN Access Point (TNAP) to a target TNAP, the UE performs a full authentication via the target TNAP to re-connect to the 5G network. Typically, a full authentication involves a security establishment at all levels, including access network security (e.g., a security establishment between the UE and the access network, or TNAN) and non-access stratum security (e.g., a security establishment between the UE and the 5G core network).

### SUMMARY

The present disclosure relates to methods, apparatuses, and systems that support UR TNAP Mobility authentication and security establishment procedures, such as procedures that utilize new input parameters and security key refreshes during the authentication and security establishment procedures, among other techniques.

Some implementations of the method and apparatuses described herein may further include a Trusted Non-3GPP Gateway Function (TNGF), comprising: a processor; and a memory coupled with the processor, the processor configured to cause the TNGF to generate a security context between a UE and a TNAP, by deriving a TNAP key using: a TNGF key, a freshness parameter, and a TNAP key refresh usage type distinguisher, deriving a re-authentication identifier using: the TNGF key, the freshness parameter, and a re-authentication identification usage type distinguisher, and sending the derived re-authentication identifier to the UE.

In some implementations of the method and apparatuses described herein, the TNGF derives the TNAP key using the TNGF key and one or more input parameters, including: re-authentication TNAP Key Refresh related usage type information, a length of the re-authentication TNAP Key Refresh usage type distinguisher, a TNGF Nonce, a length of the TNGF Nonce, a UE Nonce, and a length of the UE Nonce.

In some implementations of the method and apparatuses described herein, the TNGF generates the security context between the UE and the TNAP by deriving a Trusted IP Security (TIPSec) Key.

In some implementations of the method and apparatuses described herein, the TNGF derives the TIPSec Key using the TNGF key and one or more input parameters, including: re-authentication IPSec/IPSec Key refresh related usage type information, a length of the re-authentication IPSec/IPSec Key refresh usage type distinguisher, a TNGF Nonce, a length of the TNGF Nonce, a UE Nonce, and a length of the UE Nonce.

In some implementations of the method and apparatuses described herein, the TNGF derives the re-authentication identifier using the TNGF key and one or more input parameters, including: re-authentication identification/identifier related usage type information, a length of the re-authentication identification/identifier usage type distinguisher, a TNGF Nonce, a length of the TNGF Nonce, a UE Nonce, and a length of the UE Nonce.

In some implementations of the method and apparatuses described herein, the TNGF stores the derived re-authentication identifier with the derived TNAP key and the TNGF key.

In some implementations of the method and apparatuses described herein, the TNGF establishes over-the-air security between the UE and the TNAP using the derived TNAP key.

In some implementations of the method and apparatuses described herein, the TNGF generates the security context in response to UE mobility from a different TNAP to the TNAP for which the security context is generated by the TNGF.

In some implementations of the method and apparatuses described herein, the freshness parameter includes a TNGF Nonce, a length of the TNGF Nonce, a UE Nonce, a length of the UE Nonce, a counter, a length of a counter, a random number, or a length of a random number.

Some implementations of the method and apparatuses described herein may further include a method performed by a TNGF for generating a security context between a UE and a TNAP, including: deriving a TNAP key using a TNGF key, a freshness parameter, and a TNAP key refresh usage type distinguisher, deriving a re-authentication identifier using the TNGF key, the freshness parameter, and a re-authentication identification usage type distinguisher, and sending the derived re-authentication identifier to the UE.

In some implementations of the method and apparatuses described herein, the TNGF derives a Trusted IP Security (TIPSec) Key.

In some implementations of the method and apparatuses described herein, the TNGF stores the derived re-authentication identifier with the derived TNAP key and the TNGF key.

Some implementations of the method and apparatuses described herein may further include a UE, comprising: a processor; and a memory coupled with the processor, the processor configured to cause the UE to receive information from a TNGF, including: TNGF information, a freshness parameter, and a re-authentication identifier, and refresh a TNAP key using the information received from the TNGF and a TNAP/TNAP Key refresh related usage type distinguisher.

In some implementations of the method and apparatuses described herein, the freshness parameter includes a TNGF Nonce, a length of the TNGF Nonce, a UE Nonce, a length of the UE Nonce, a counter, a length of a counter, a random number, or a length of a random number.

In some implementations of the method and apparatuses described herein, the UE establishes a security context with a TNAP associated with the TNGF using the refreshed TNAP key.

Some implementations of the method and apparatuses described herein may further include a method performed by a UE, the method comprising: receiving information from a TNGF, including: TNGF information, a freshness parameter, and a re-authentication identifier, and refreshing a TNAP key using the information received from the TNGF and a TNAP/TNAP Key refresh related usage type distinguisher.

In some implementations of the method and apparatuses described herein, the freshness parameter includes a TNGF Nonce, a length of the TNGF Nonce, a UE Nonce, a length of the UE Nonce, a counter, length of a counter, a random number, or a length of a random number.

In some implementations of the method and apparatuses described herein, the UE establishes a security context with a TNAP associated with the TNGF using the refreshed TNAP key.

Some implementations of the method and apparatuses described herein may further include a processor for wireless communication comprising at least one controller coupled with at least one memory and configured to cause the processor to receive information from a TNGF, including TNGF information, a freshness parameter, and a re-authentication identifier and refresh a TNAP key using the information received from the TNGF and a TNAP/TNAP Key refresh related usage type distinguisher.

In some implementations of the method and apparatuses described herein, the freshness parameter includes a TNGF Nonce, a length of the TNGF Nonce, a UE Nonce, a length of the UE Nonce, a counter, a length of a counter, a random number, or a length of a random number.

In some implementations of the method and apparatuses described herein, the processor establishes a security context with a TNAP associated with the TNGF using the refreshed TNAP key.

### BRIEF DESCRIPTION OF THE DRAWINGS

FIG. 1 illustrates an example of a wireless communications system that supports TNAP Mobility in accordance with aspects of the present disclosure.

FIG. 2 illustrates an example of a diagram that supports UE mobility from a source TNAP to a target TNAP in accordance with aspects of the present disclosure.

FIG. 3 illustrates an example of a diagram that supports authentication and Protocol Data Unit (PDU) Session establishment for Trusted Non-3GPP access in accordance with aspects of the present disclosure.

FIG. 4 illustrates an example of a diagram that supports a security establishment procedure for TNAP Mobility in accordance with aspects of the present disclosure.

FIG. 5 illustrates an example of a diagram that supports a UE TNAP Mobility Procedure in accordance with aspects of the present disclosure.

FIG. 6 illustrates an example of a diagram that supports TNAP Mobility using a Fast BSS (Basic Service Set) Transition (FT) protocol in accordance with aspects of the present disclosure.

FIG. 7 illustrates an example of a block diagram of a device that supports TNAP Mobility in accordance with aspects of the present disclosure.

FIG. 8 illustrates a flowchart of a method that supports establishing an IPSec Security Association between a UE and a TNGF in accordance with aspects of the present disclosure.

FIG. 9 illustrates a flowchart of a method that supports authentication of a UE to a TNGF in accordance with aspects of the present disclosure.

FIG. 10 illustrates a flowchart of a method that supports generating a security context between a UE and a TNAP in accordance with aspects of the present disclosure.

FIG. 11 illustrates a flowchart of a method that supports generating a security context for a UE in accordance with aspects of the present disclosure.

### DETAILED DESCRIPTION

During UE TNAP Mobility, the access network changes, while the core network remains unchanged. Thus, current procedures that cause the UE to perform a full authentication with the core network during TNAP Mobility can lead to inefficiencies, such as unnecessary multiple message exchanges between the UE and the core network. These message exchanges can cause resource exhaustion and delays during the re-establishment of the connection between the UE and the core network.

In some cases, a 5G network could support both the re-authentication and the security establishment of the UE to the core network without performing the full authentication procedures, such as by enabling a fresh TNAP key generation at a TNGF (Trusted Non-3GPP Gateway Function) associated with a target TNAP. However, some issues can arise, such as (1) the reuse of the same Trusted Access IP Security (TIPSec) Key (K_{TIPSec}) to perform IKE_Auth messaging and secure connection establishment between the UE and a TNGF via the target TNAP, (2) a re-authentication ID (e.g., Re-auth ID) and new TNAP key (for the target TNAP) that is generated can result in the same output due to same input usage for the key derivation function, which can lead to an exposure of a new TNAP key, among other drawbacks.

The technology described herein adapts the UE TNAP Mobility authentication and security establishment procedures to avoid reliance on full authentication during UE Mobility between TNAPs without the various issues described herein (e.g., key reuse).

For example, the technology provides for re-authentication identity or identifier (ID) generation using new input parameters. The input parameters can include a usage type parameter, such as “re-authentication identification/identifier related usage type information,” to distinguish the ID from the other security keys generated from a same or shared root key (e.g., a TNGF Key).

Further, the technology provides for a TNAP Key (K_{TNAP}) refresh by a UE and/or a TNGF using a TNGF Key, as well as other input parameters, such as freshness parameters (e.g., Nonces, Counter, Random, and so on) and/or a re-authentication TNAP/TNAP Key Refresh related usage type distinguisher.

The technology can also provide a TIPSec Key (K_{TIPSec}) refresh mechanism between a UE and a TNGF to establish a secure connection (e.g., an IPSec following IKE_Auth messaging between the UE and the TNGF).

Also, the technology can provide for an exchange of a re-auth ID during IKE_Auth message within ID Payloads to indicate a UE context containing a UE TNAP Mobility related re-authentication security context. The re-authentication security context, which includes a fresh K_{TIPSec}, can identify and establish the security connection (e.g., the IPSec) between the UE and the TNGF.

Thus, by utilizing the technology described herein, the 5G network can support UE TNAP Mobility without reliance on the full authentication procedures and while avoiding issues with security key reuse and related drawbacks.

Aspects of the present disclosure are described in the context of a wireless communications system. Aspects of the present disclosure are further illustrated and described with reference to device diagrams and flowcharts.

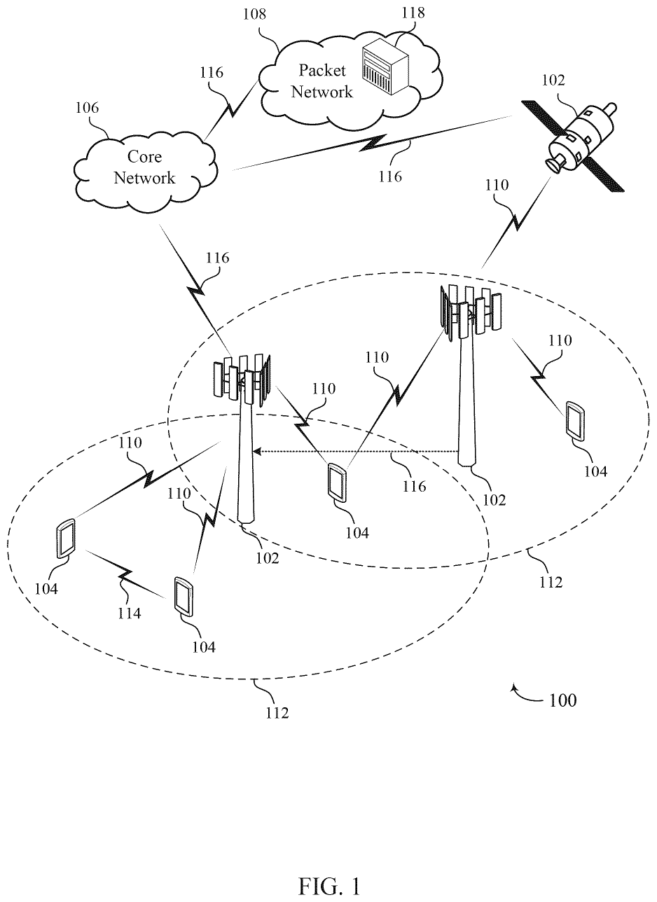

FIG. 1 illustrates an example of a wireless communications system 100 that supports Trusted TNAP Mobility in accordance with aspects of the present disclosure. The wireless communications system 100 may include one or more network entities 102, one of more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WIMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UB 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PCS interface.

A network entity 102 may support communications with the core network 106, or with another network entity 102, or both. For example, a network entity 102 may interface with the core network 106 through one or more backhaul links 116 (e.g., via an S1, N2, N3, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N3, or another network interface). The packet data network 108 may include an application server 118. In some implementations, one or more UEs 104 may communicate with the application server 118. A UE 104 may establish a session (e.g., a protocol data unit (PDU) session, or the like) with the core network. 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ==4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHZ-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3) which includes 120 kHz subcarrier spacing.

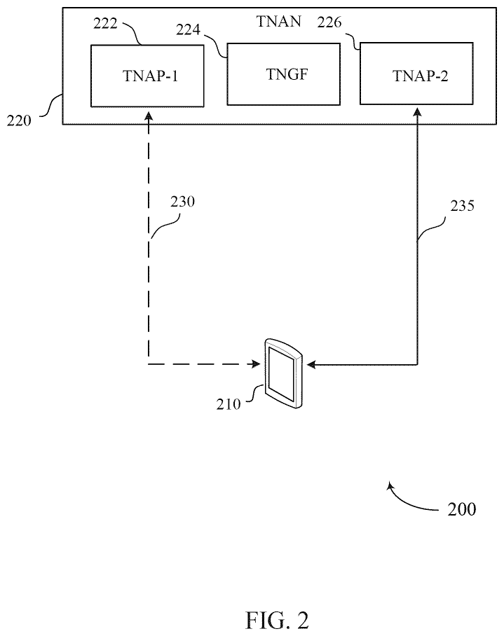

As described herein, a 5G network can utilize various techniques to provide authentication and security establishment between a UE and a core network during UE TNAP Mobility, without employ a full authentication procedure for the UE. FIG. 2 illustrates an example of a diagram 200 that supports UE mobility from a source TNAP to a target TNAP in accordance with aspects of the present disclosure.

For example, a UE 210, which is connected to a 5G core network (such as a TNAN) 220 moves from a source TNAP 222 (e.g., TNAP-1) to a target TNAP 226 (e.g., TNAP-2). The TNAP-1 and TNAP-2 are associated with a TNGF 224 of the TNAN 220. During UE Mobility of the UE 210, the UE 210, which had a secure connection 230 to the source TNAP 222, connects 235 with the target TNAP 226. As described herein, the UE 210 moves between access points (e.g., from TNAP-1 to TNAP-2), and thus the TNAN 220 can utilize the various authentication and security establishment procedures described herein to authenticate/establish the UE 210 to the target TNAP 226, without performing a full authentication (e.g., procedures that involve components of the core network itself).

In some embodiments, a TNGF (e.g., the TNGF 224) can derive a unique re-authentication identity/identifier (e.g., Re-auth ID) to identify a security context related to the UE (e.g., the UE 210), which can derive and utilize any re-authentication specific security context.

Further, in some cases, the TNGF can generate a fresh TNAP key and/or TIPSec key during UE TNAP Mobility, to re-establish security connections between the UE and a target TNAP (e.g., the target TNAP 226), as well as to re-establish an IP security association between the UE and the TNGF during the UE TNAP Mobility.

An initial registration procedure (e.g., after a successful authentication for access to the NTAN 220) includes generation of a Re-auth ID by a TNGF and/or UE to enable an identification of the UE context to support the UE TNAP Mobility related re-authentication and security establishment. Further, the security establishment procedure can be adaptable to support a UE moving from a source TNAP (e.g., TNAP-1) to a target TNAP (e.g., TNAP-2) during UE Mobility.

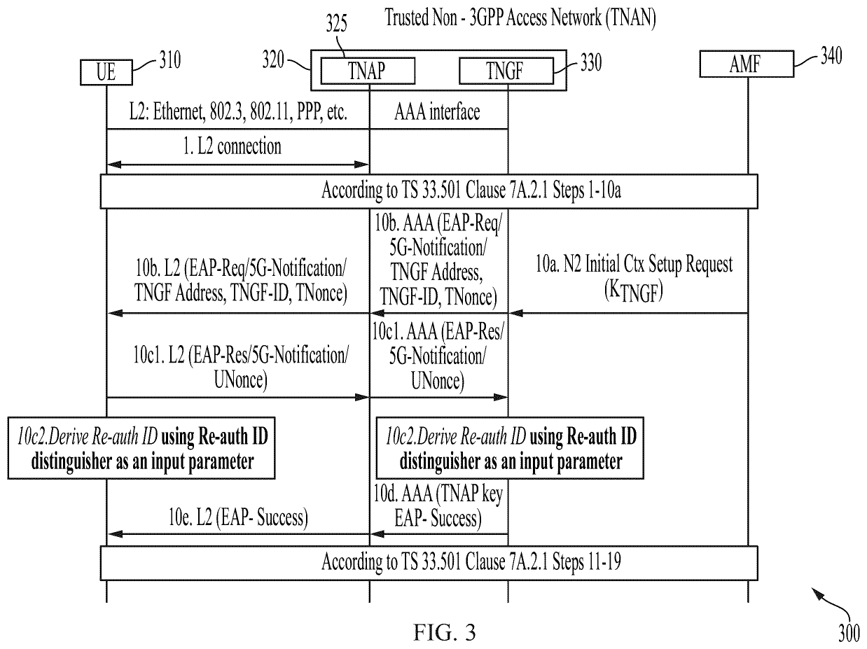

FIG. 3 illustrates an example of a diagram 300 that supports authentication and Protocol Data Unit (PDU) Session establishment for Trusted Non-3GPP access in accordance with aspects of the present disclosure. The procedure can include the following steps (and new adaptations):
Step 0: A UE 310 selects a PLMN and a TNAN 320 for connecting to this PLMN by using the Trusted Non-3GPP Access Network selection procedure. The UE 310 discovers the PLMNs with which the TNAN 320 supports trusted connectivity (e.g., “5G connectivity”).
Step 1: A layer-2 connection is established between the UE 310 and a TNAP 325.
Steps 2-10a: An EAP authentication procedure is initiated. EAP messages shall be encapsulated into layer-2 packets. Between the TNAP 325 and TNGF 330 the EAP packets are encapsulated into AAA messages. An EAP-5G procedure is executed. During this procedure authentication and key agreement happens between the UE 310 and the network. A K_{TNGF} key is created in the UE 310 and in an AMF 340 after the successful authentication. The K_{TGNF} is transferred from the AMF 340 to TNGF 330 in step 10a.
Step 10b: The TNGF 330 sends TNGF address and TNGF Nonce (TNonce) (e.g., information required to generate a Re-auth ID) to the UE 310, The TNAP 325 is a trusted entity. The TNGF 330 can generate the KINAP (e.g., the TNAP Key) and transfers it from TNGF 330 to TNAP 325 in step 10b (within an AAA message).
Step 10c1: The UE sends to TNGF 330 a UE Nonce (UNonce) (e.g., information required to generate a Re-auth ID).
Step 10c2: The UE 310 and the TNGF 330 can derive a Re-auth ID for the UE 310 from TNGF key using the inputs parameters such as TNGF-ID/address, Nonce from TNGF, Nonce from UE and a re-authentication identification/identifier related usage type information (e.g., 0x03).

When deriving a Re-auth ID from K_{TNGF} the following parameters can be used to form the input S to the KDF:
FC=0xxx (e.g., any value);
P0=Usage type distinguisher (i.e., re-authentication identification/identifier related usage type information (e.g., 0x03);
L0=length of Usage type distinguisher (e.g., 0x00 0x01);
P0=TNGF Nonce;
L0=Length of TNGF Nonce;
P0=UE Nonce;
L0=Length of UE Nonce; and so on.

In some cases, the usage type distinguisher Re-authentication Identification/Re-authentication Identifier can also be termed a UE context identifier for UE TNAP Mobility Re-authentication.

In some cases, the usage type distinguishers related to the UE TNAP Mobility have the following values:

TABLE 1
Usage Type Distinguishers

| Usage type distinguisher | Value |
|---|---|
| IPSec | 0x01 |
| TNAP | 0x02 |
| Re-authentication Identification/Re- | 0x03 |
| authentication Identifier | |
| Re-authentication TNAP/TNAP Key Refresh | 0x04 |
| Re-authentication IPSec/IPSec Key Refresh | 0x05 |

Steps 10d-e: The TNGF 330 can generate the K_{TNAP} (TNAP Key) if not derived in step 10b and transfer the key from the TNGF 330 to the TNAP 325 (within an AAA message). Further, the TNGF 330 can also send a message containing the EAP-Success packet.
Step 11: The common TNAP key is used by the UE 310 and TNAP 325 to derive security keys according to the applied non-3GPP technology and to establish a security association to protect all subsequent traffic. In case of IEEE 802.11 [80], the K_{TNAP} is the Pairwise Master Key (PMK) and a 4-way handshake is executed (see IEEE 802.11 [80]) which establishes a security context between the WLAN AP and the UE 310 that is used to protect unicast and multicast traffic over the air. All messages between UE 310 and TNAP 325 are encrypted and integrity protected from this step onwards.
Step 12: The UE 310 receives IP configuration from the TNAN 320, e.g., with DHCP.
Step 13: The UE 310 shall initiate an IKE_INIT exchange with the TNGF 330, The UE 310 has received the IP address of TNGF 330 during the EAP-5G signalling in step 9b, subsequently, the UE 310 shall initiate an IKE_AUTH exchange and shall include the same UE Id (e.g., SUCI or 5G-GUTI) as in the UE Id provided in step 5. The common K_{TIPSec} is used for mutual authentication. The key K_{TIPSec} is derived as specified in Annex A.22.NULL encryption is negotiated as specified in RFC 2410. After step 13c, an IPsec SA (Security Association) is established between the UE 310 and the TNGF 330 (e.g., a NWt connection) and it is used to transfer all subsequent NAS messages. This IPsec SA does not apply encryption but only apply integrity protection.
Step 14: After the NWt connection is successfully established, the TNGF 330 responds to AMF 340 with an N2 Initial Context Setup Response message.
Step 15: Finally, the NAS Registration Accept message is sent by the AMF 340 and is forwarded to UE 310 via the established NWt connection.
Steps 16-18: The UE 310 initiates a PDU session establishment. The TNGF 330 may establish one or more IPSec child SA's per PDU session.
Step 19: User plane data for the established PDU session is transported between the UE 310 and TNGF 330 inside the established IPSec child SA.

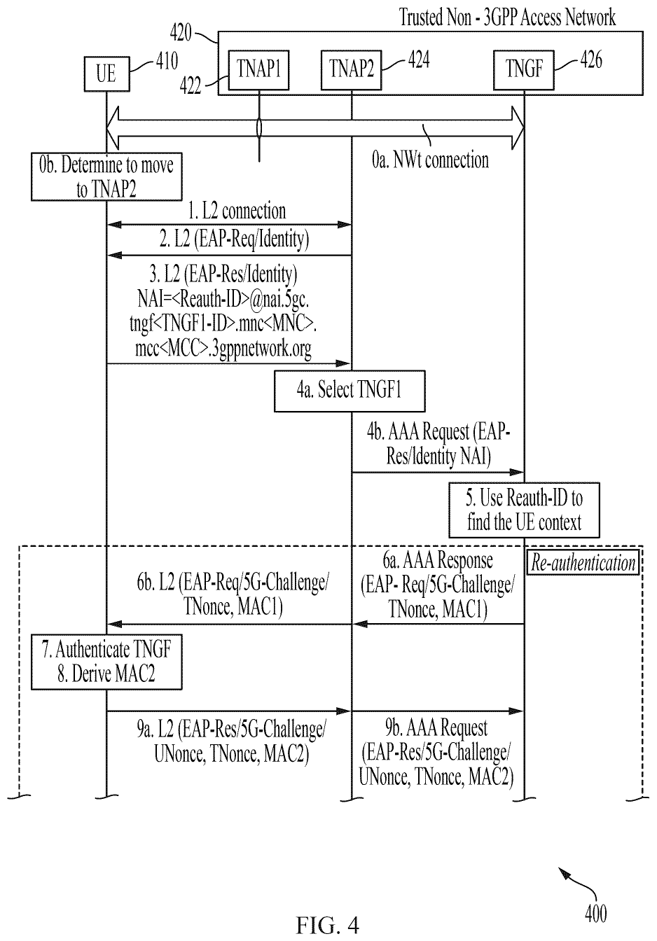

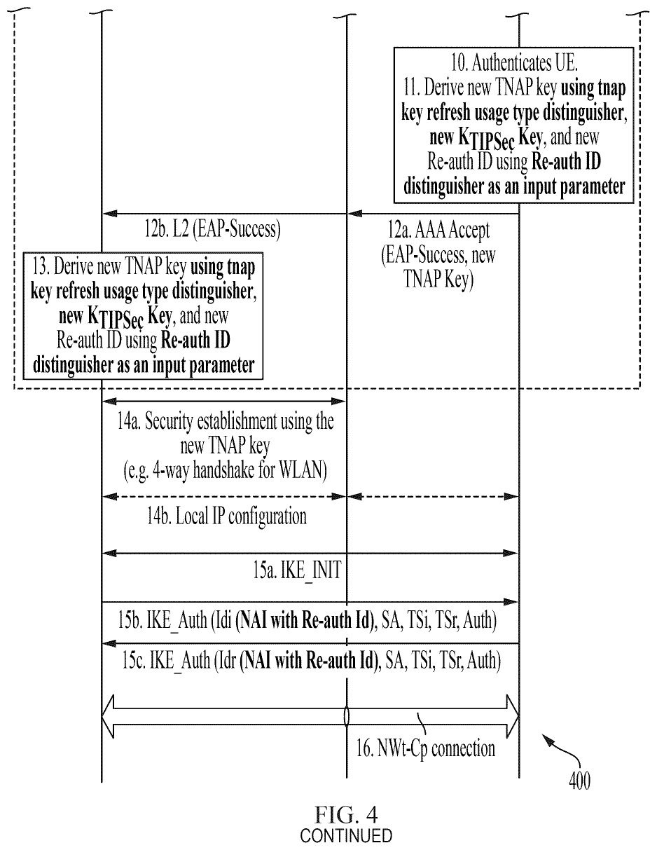

In some embodiments, a UE TNAP Mobility Scenario can include a UE moving from one TNAP (e.g., TNAP-1) to another TNAP (e.g., TNAP-2) that are connected to or associated with the same TNGF (e.g., TNGF 224), or the TNAPs belong to the same TNGF domain. FIG. 4 illustrates an example of a diagram 400 that supports a security establishment procedure for TNAP Mobility in accordance with aspects of the present disclosure.

The procedure can include the following steps (and new adaptations), where Nonces and usage type distinguishers can be inputs:
Step 1: A UE 410 established a layer-2 (L2) connection with a TNAP2 424.
Step 2: The TNAP2 424 initiates an EAP session as usually by requesting the UE 410 identity.
Step 3: The UE 410 provides a Network Access Identifier (NAI) containing username=Reauth-ID and realm=nai.5gc.tngf<TNGF-ID>mnc<MNC>mcc<MCC>3gppnetwork.org.

The Reauth-ID was derived as described herein and the TNGF-ID was received when the UE 410 was first connected to a TNGF 426 of an TNAN, e.g., with an Initial Registration via the TNGF 426. The UE 410 provides username=Re-auth ID because the UE 410 does not want to initiate NAS signaling with 5GC, but it wants to reauthenticate with the TNGF 426.
Step 4: A TNAP1 422 selects the TNGF 426 based on the TNG1-ID in the received realm and forwards the NAI to TNGF 426.
Step 5. The TNGF 426 finds a stored UE context containing the received Re-auth ID, thus, it determines that the UE 410 is a known UE which requests reauthentication. Therefore, it initiates the following steps. If the TNGF 426 cannot find a stored UE context containing the received Re-auth ID, then the TNGF 426 sends either an error response to UE 410, it initiates the signalling procedure related to normal full authentication for trusted non-3GPP access as described herein and in TS 33.501 Clause 7A.2.1. In some cases, the UE context was created in the TNGF 426 when the UE 410 performed an initial registration (see FIG. 3) via a TNGF.
Step 6: The TNGF 426 sends a 5G-Challenge packet to UE 410 which contains a TNonce value and a Message Authentication Code1 (MAC1) derived by using the TNGF key stored in TNGF 426.
Step 7: The UE 410 derives an expected MAC1 (XMAC1) using TNGF key stored in UE 410, and TNonce and compares XMAC1 with the received MAC1. If they match, the TNGF 426 is authenticated by the UE 410.
Step 8: The UE 410 generates a UNonce and derives a MAC2 using TNGF key stored in UE 410, and with UNonce and TNonce.
Step 9: The UE 410 responds with a 5G-Challenge containing UNonce, TNonce and MAC2.
Step 10: The TNGF 426 derives an expected MAC2 (XMAC2) using TNGF and with UNonce and TNonce. Compares XMAC2 with the received MAC2. If they match, the UE 410 is authenticated by TNGF 426.
Step 11: The TNGF 426 derives a fresh Re-auth ID for the UE, e.g., by using TNGF key stored in TNGF, TNGF-ID, TNonce, UNonce (exchanged in step 6a, 6b, 9a, 9b) and re-authentication identification/identifier related usage type information (e.g., 0x03). In addition, the TNGF 426 derives a new TNAP key by using the TNGF key stored in TNGF, the TNGF-ID, the TNonce, UNonce values and a usage type distinguisher specific to the Re-authentication TNAP/TNAP Key Refresh.

When deriving a fresh K_{TNAP} from K_{TNGF} the following parameters can be used to form the input S to the KDF:
FC=0xxx (e.g., any value);
P0=Usage type distinguisher (i.e., Re-authentication TNAP/TNAP Key Refresh related usage type information (e.g., 0x04));
L0=length of Usage type distinguisher (e.g., 0x00 0x01);
P0=TNGF Nonce;
L0=Length of TNGF Nonce;
P0=UE Nonce;
L0=Length of UE Nonce; and so on.

Further, if the TNGF 426 determines or is configured to reestablish the secure connection (e.g., IP see between UE 410 and TNGF 426) with the UE 410 via the new target TNAP-2 (e.g., TNAP2 424), the TNGF 426 can refresh the K_{TIPSec}. When deriving a fresh K_{TIPSec} from K_{TGNF} the following parameters can be used to form the input S to the KDF:
FC=0xxx (e.g., any value);
P0=Usage type distinguisher (i.e., Re-authentication IPSec/IPSec Key Refresh related usage type information (e.g., 0x05));
L0=length of Usage type distinguisher (e.g., 0x00 0x01);
P0=TNGF Nonce;
L0=Length of TNGF Nonce;
P0=UE Nonce;
L0=Length of UE Nonce; and so on.

In some cases, the TNGF 426 stores the Re-auth ID (derived as described herein and received as the current Re-auth ID), along with UE context such as the TNGF Key, a new TNAP Key, a new TIPSec Key, and Re-auth ID (derived in step 11 as the future/new Re-auth ID).
Step 12: The TNGF 426 completes the EAP-5G session by sending an EAP-Success packet to UE 410 and the new TNAP key to TNAP2. 424.
Step 13: The UE 410 derives a new Re-auth ID by using the TNGF key stored in UE, TNGF-ID, TNonce, UNonce and re-authentication identification/identifier related usage type information (e.g., 0x03) similar to the TNGF (as described in step 11). If the UE 410 and the TNGF 426 share the same TNGF key, then the Reauth-ID derived independently in the UE 410 and in the TNGF will be the same. In addition, the UE 410 also derives a new/fresh TNAP key using the TNGF key stored in UE, TNGF-ID, TNonce, UNonce, and a usage type distinguisher specific to the Re-authentication TNAP/TNAP Key Refresh (e.g., 0x04) similarly to the TNGF (as in step 11). Additionally, the UE 410 also derives new/fresh TIPSec Key using the TNGF key stored in UE, TNGF-ID, TNonce, UNonce, and a usage type distinguisher specific to Re-authentication IPSec/IPSec Key Refresh (e.g., 0x05) similar to the TNGF.

In some cases, the TNGF 426 provides the Re-auth ID generated in step 11 to the UB 410 in step 12a and 12b. Further, the UE can store the Re-auth ID (derived/received in FIG. 3 and sent in step 4b as the current Re-auth ID), along with UE context such as the TNGF Key, new TNAP Key, new TIPSec Key, and Re-auth ID (derived in step 13 or received in step 12b as the future/new Re-auth ID).
Steps 14a-b: The new TNAP key is applied to establish over-the-air security between the UE 410 and TNAP2 424. In some cases the UE 410 may receive new IP configuration information (e.g., a new IP address) from the TNAN 420.
Steps 15a-c: The UE 410 can initiate an IKE_INIT exchange with the TNGF 426. The UE 410 has received the IP address of TNGF in the earlier steps, subsequently, the UE can initiate (in step 15b) an IKE_AUTH exchange, which can include the NAI containing the Re-auth ID (or Reauth-ID) as in the UE Id provided in step 3. For the IKE_AUTH exchange part in step 15a, names in the ID payloads may correspond to the keys used to generate the AUTH payload. In case the UE 410 utilizes the Re-auth ID based NAI/Re-auth ID in step 5, the UE 410 shall initiate an IKE_AUTH exchange and shall include the Re-auth ID based NAI/Re-auth ID in ID payloads. To help TNGF 426 identify fresh K_{TIPSec}, the Re-auth ID based NAI/Re-auth ID is used in step 13b. The fresh K_{TIPSec} derived (in step 11 by TNGF and 13 by UE) is used for mutual authentication. NULL encryption is negotiated as specified in RFC 2410. After step 15c, an IPsec SA is established between the UE 410 and TNGF 426 (e.g., a NWt connection) and is used to transfer all subsequent NAS messages. This IPsec SA applies integrity protection.
Step 16: The UE 410 resumes communication with TNGF 426 via TNAP2 424.

In some embodiments, a TNGF (e.g., the TNGF 426) can derive a unique re-authentication identity/identifier (e.g., Re-auth ID) to identify the security context related to the UE to derive and use any re-authentication specific security context. Further, the TNGF can generate a fresh TNAP key and/or TIPSec key during the UE TNAP mobility to re-establish security connections between the UE and a target TNAP, as well as to re-establish IP security associations between the UE and TNGF during UE TNAP mobility.

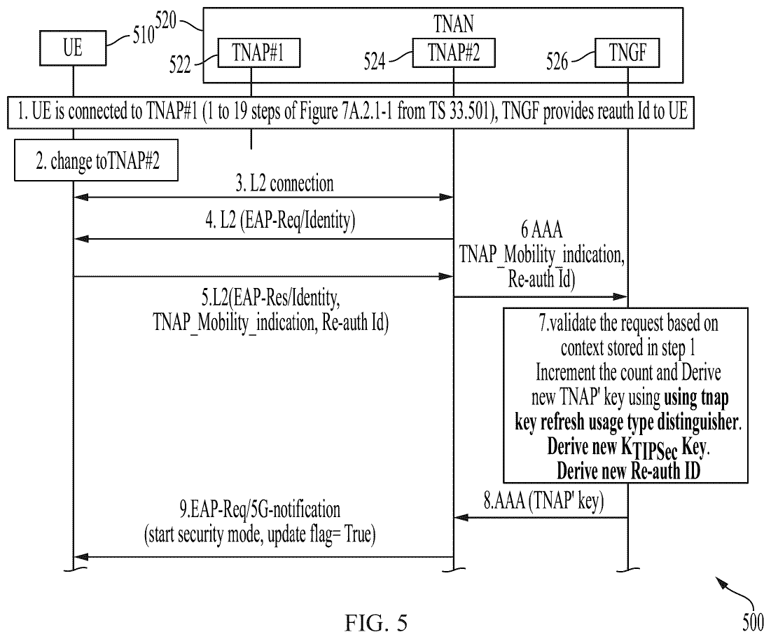

FIG. 5 illustrates an example of a diagram 500 that supports a UE TNAP Mobility Procedure in accordance with aspects of the present disclosure. The procedure can include the following steps (and new adaptations), where random numbers, counters, and/or usage type distinguishers can be inputs:
Step 1: A UE 510 is connected to a TNAP #1 522 of a TNAN 520 by performing authentication for trusted non-3GPP access with the 5G system. Once authenticated, a TNGF 526 of the TNAN 520 sends the re-auth Id to UE 510 over the protected interface (e.g., in any step 10b or 10d of FIG. 3). The Re-auth ID can be a generated as <PLMNID><TNGF_ID><Temp Id>, where the Temp Id can be equivalent to the TNGF nonce described herein. In some cases, the TNGF 526 may contain TNGF Address (e.g., FQDN) Information.
Steps 2, 3: The UE 510 decides to move from the TNAP #1 522 to a TNAP #2 524 and creates an L2 connection with TNAP #2 524.
Steps 4, 5, 6: TNAP #2 524 sends the L2 EAP-Request for Identity towards the UE 510 and the UE 510 responds back with an L2 EAP-Response with Identity (e.g., Re-auth ID) and a TNAP_Mobility_Indication flag. The TNAP2 524 forwards the EAP response with Re-auth ID and the TNAP Mobility Indication flag towards TNGF 526.
Step 7-8: Based on the Re-auth ID, TNGF 526 identifies the UE 510 and retrieves the context and TNAP_Mobility_Indication, and the TNGF 526 checks if the stored context in step 1 is valid and then derives the TNAP keys as described herein. The TNGF 526 responds back to TNAP #2 524 with the generated key RAND (random number) value and MAC for the RAND value. The Message Authentication Code (MAC) is derived by using the TNGF key stored in TNGF 526. In TNAP #2 524, the newly received TNAP key is considered as a Pairwise Master Key (PMK). In some cases, instead of RAND, a counter be used as a freshness parameter.

In some embodiments, a derivation of the key K_{TNAP} from the key KTNGF during mobility can include some or all of the following input parameters:
FC=0xWX;
P1=RAND/COUNTER;
L1=length of RAND (e.g., 0x00 0x04);
P2=a usage type distinguisher specific to the Re-authentication TNAP/TNAP Key Refresh;
L2=Length of the usage type distinguisher specific to the Re-authentication TNAP/TNAP Key Refresh; and so on.

The input key KEY can be the KTNGF. When KTNAP′ is derived in Mobility, the RAND/COUNTER can be generated and shared with the UE 510. Further, when the TNGF 526 determines or is configured to reestablish the secure connection (e.g., IP sec between UE 510 and TNGF 526) with the UE 510 via the new target TNAP #2 524, the TNGF 526 can refresh the K_{TIPSec}. For example, when deriving a fresh K_{TIPSec} from K_{TNGF} the following parameters can be used to form the input S to the KDF:
FC=0xxx (e.g., any value);
P0=Usage type distinguisher (e.g., Re-authentication IPSec/IPSec Key
Refresh related usage type information (e.g., 0x05));
L0=length of Re-authentication IPSec/IPSec Key Refresh specific Usage type distinguisher (e.g., 0x00 0x01);
P0=RAND/COUNTER;
L0=Length of RAND/COUNTER; and so on.

The TNGF 526 stores the Re-auth ID (derived herein), along with UE context such as the TNGF Key, new TNAP Key, new TIPSec Key, and Re-auth ID (derived in step 11 as the future/new Re-auth ID). In some cases, the input key KEY shall be KTNGF. Further, when a fresh K_{TIPSec}′ is derived in Mobility, the RAND/COUNTER can be generated and shared with the UE 510.
Steps 9, 10, 11: The TNAP #2 524 sends an EAP-notification back to the UE 510 with the RAND value along with MAC. If MAC validation is successful then based on the RAND value, UE 510 derives the keys. A 4-way handshake is executed (see IEEE 802.11) which establishes a security context between the WLAN AP and the UE 510 that is used to protect unicast and multicast traffic over the air. In some cases, a counter can be used instead of the RAND.

Once the procedure is complete, the TNGF 526 sends the new Re-auth ID Id to UE 510 over the secure interface (e.g., in Step 17a-b or in any steps after step 7), which the UE 510 can use for the next interaction. The Re-auth ID can be derived similar to step 1, but with a new TNGF Nonce or new Temp ID, e.g., Re-auth ID can be a generated as <PLMNID><TNGF_ID><new Temp Id or new TNGF Nonce>.

In some cases, a hash/MAC of the new TNAP key generated in step 7 and the Re-auth ID related usage type distinguisher can be used as the new Temp ID in step 7 or in later steps to generate the new Re-auth ID.
Step 12: The new TNAP key is applied to establish over-the-air security between the UE 510 and TNAP #2 524. If needed, the UE 510 may receive new IP configuration information (e.g., a new IP address) from the TNAN 520. When the UE 510 gets the new IP configurations from TNAP #2 524, then the UE 510 updates the SA address using an IKE informational request “UPDATE_SA_ADDRESS” to TNGF 526 for further communications.
Steps 13a-c: The UE 510 can initiate an IKE_INIT exchange with the TNGF 526. The UE 510 has received the IP address of TNGF 526 in the earlier steps, subsequently, the UE 510 can initiate (in step 13b) an IKE_AUTH exchange which can include the NAI containing the Re-auth ID or Re-auth ID as in the UE Id provided in earlier step 3. For the IKE_AUTH exchange part in step 13a, names in the ID payloads should correspond to the keys used to generate the AUTH payload. In case the UE 510 utilizes the Re-auth ID based NAI/Re-auth ID in step 5, the UE 510 shall initiate an IKE_AUTH exchange and shall include the Re-auth ID based NAI/Re-auth ID in ID payloads. To help TNGF identify fresh K_{TIPSec}, the Re-auth ID based NAI/Re-auth ID is used in step 13b. The fresh K_{TIPSec} derived (in step 11 by TNGF and 13 by UE) is used for mutual authentication. NULL encryption is negotiated as specified in RFC 2410.

After step 15c, an IPsec SA is established between the UE 510 and TNGF 526 (e.g., a NWt connection) and the connection is used to transfer all subsequent NAS messages. The IPsec SA applies integrity protection.
Step 16: The UE 510 resumes communication with TNGF 526 via TNAP #2 524.
Step 17a-b: The TNGF 526 sends the new Re-auth ID generated in earlier steps to the UE 510 via the TNAP #2 524. In some cases, the UE 510 can derive the new Re-auth ID as derived by the TNGF 526 (e.g., Re-auth ID can be a generated as <PLMNID><TNGF_ID><new Temp Id>, where a hash/MAC of the new TNAP key generated in step 10 and the Re-auth ID related usage type distinguisher can be used as the new Temp ID.

In some embodiments, the TNAP Mobility can utilize a Fast BSS Transition protocol. A. FT key hierarchy is established based on the Master Session Key (MSK) by the R0 Key Holder (R0KH) that is co-located with an 802.1X authenticator. To support the Fast BSS Transition, the entity that will hold the root key can obtain a 256 bit key (K_{FT}) from a TNGF, which is then used as an input key to create the FT key hierarchy.

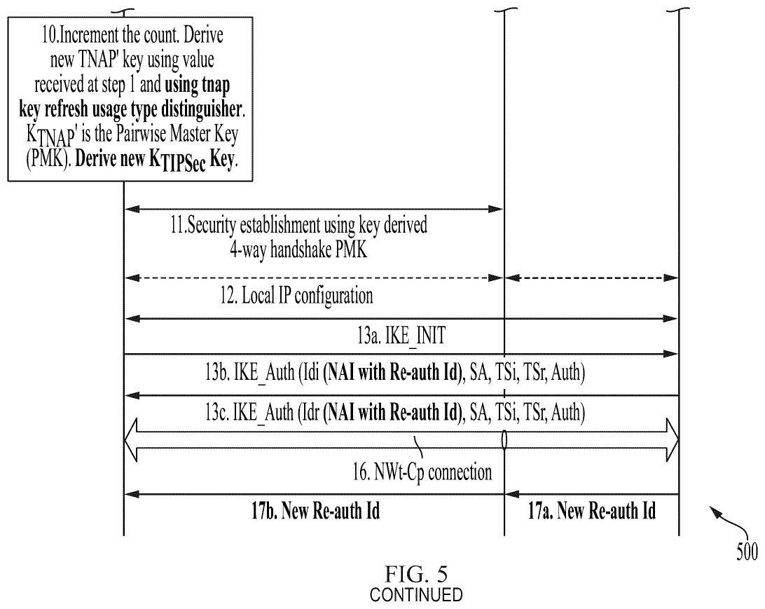

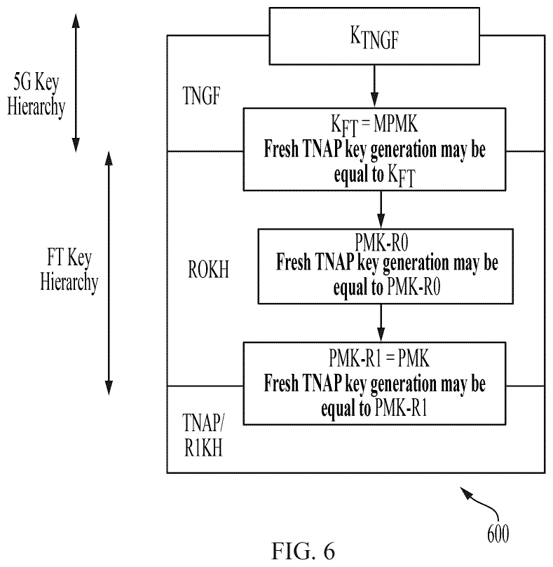

FIG. 6 illustrates an example of a diagram 600 that supports TNAP Mobility using a Fast BSS (Basic Service Set) Transition (FT) protocol in accordance with aspects of the present disclosure. The key K_{FT} is derived from KINor using fixed inputs similar to the derivation of K_{TNAP} from K_{TGNF} described in Annex A.22 of TS 33.501, but using a new Usage type distinguisher, e.g. 0x03. The key K_{FT} is used to create the FT key hierarchy specified in 802.11. Specifically, K_{FT} is used as Master PMK (MPMK) that is used as an input key for R0-Key-Data derivation. With the R0-Key-Data, the FT key hierarchy is established. In effect, K_{FT} links the 5G key hierarchy and FT key hierarchy as it is derived from a key in the 5G key hierarchy and being used to create the FT key hierarchy.

When a UE switches to a new TNAP within the same mobility domain identified by the Mobility domain identifier (MDID), the UE performs the fast BSS transition procedure. The entity that has received K_{FT} from the TNGF takes the role of PMK R0 Key Holder (R0KH) that holds the key, PMK-R0. The R0KH derives PMK-R1 from PMK-R0 and provides it to the new AP (e.g., TNAP in TNAN) during the FT procedure.

In some cases (e.g., TNAP mobility using the Fast BSS Transition protocol), the steps for the key handling during a TNAP change are as follows:
Step 1: Before the TNAP change the following has happened, R0 Key Holder (R0KH) (entity that holds the FT root key) has received K_{FT} from the TNGF and has used this to derive PMK-R0 which the R0KH stores to derive further keys. The UE is connected to a TNAP.
Step 2: The UE contacts the new TNAP.
Step 3: The new TNAP contacts the R0KH to request a key for the UE. The R0KH calculates the key PMK-R1 from PMK-R0 and sends a PMK-R1 to the new TNAP.
Step 4: The UE and new TNAP use PMK-R1 as the pairwise master key to secure the connection between the UE and new TNAP.

As shown in FIG. 6, the 5G and FT key hierarchies link together. The TNGF can send both K_{TNAP} and K_{FT} to the entity that holds the root key of the FT key hierarchies and MSK. The TNGF sets the MSK to K_{TNAP}∥K_{FT}, where MSK is 512 bits and the K_{TNAP} and K_{FT} are 256 bits. The TNGF sends the MSK using existing mechanisms.

Also, the TNGF can send both K_{TNAP} (e.g., a fresh TNAP Key generated) and K_{FT} to the entity that holds the root key of the FT key hierarchies and MSK. The TNGF sets the MSK to K_{TNAP}∥K_{FT}, where MSK is 512 bits and the K_{TNAP} and K_{FT} are 256 bits. The TNGF sends the MSK using mechanisms described herein. In some cases, the fresh TNAP key generation and usage is based on various techniques described herein.

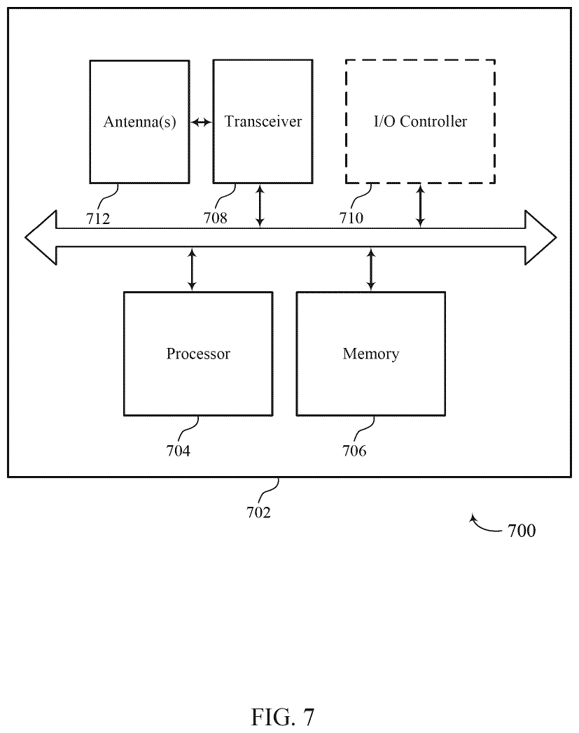

FIG. 7 illustrates an example of a block diagram 700 of a device 702 that supports UE TNAP Mobility in accordance with aspects of the present disclosure. The device 702 may be an example of a network entity 102 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for deriving a TIPSec Key using a TNGF Key, an input parameter, and a re-authentication usage type distinguisher, receiving, from a UE, a re-authentication identifier for the UE, identifying the TIPSec Key using the re-authentication identifier, and re-establishing an IPSec SA based on the identified TIPSec Key.

As another example, the processor 704 may support wireless communication at the device 702 in accordance with examples as disclosed herein. The processor 704 may be configured as or otherwise support a means for deriving a TIPSec Key using, a stored TNGF Key, an input parameter, and a re-authentication usage type distinguisher, and transmitting, to a TNGF, a re-authentication identifier for the UE.

As another example, the processor 704 may support wireless communication at the device 702 in accordance with examples as disclosed herein. The processor 704 may be configured as or otherwise support a means for generating a security context between a UE and a TNAP by deriving a TNAP key using a TNGF key, a freshness parameter, and a TNAP key refresh usage type distinguisher, deriving a re-authentication identifier using the TNGF key, the freshness parameter, and a re-authentication identification usage type distinguisher, and sending the derived re-authentication identifier to the UE.

As another example, the processor 704 may support wireless communication at the device 702 in accordance with examples as disclosed herein. The processor 704 may be configured as or otherwise support a means for receiving information from a TNGF, including TNGF information, a freshness parameter, and a re-authentication identifier, and refreshing a TNAP key using the information received from the TNGF and a TNAP/TNAP Key refresh related usage type distinguisher.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O) system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

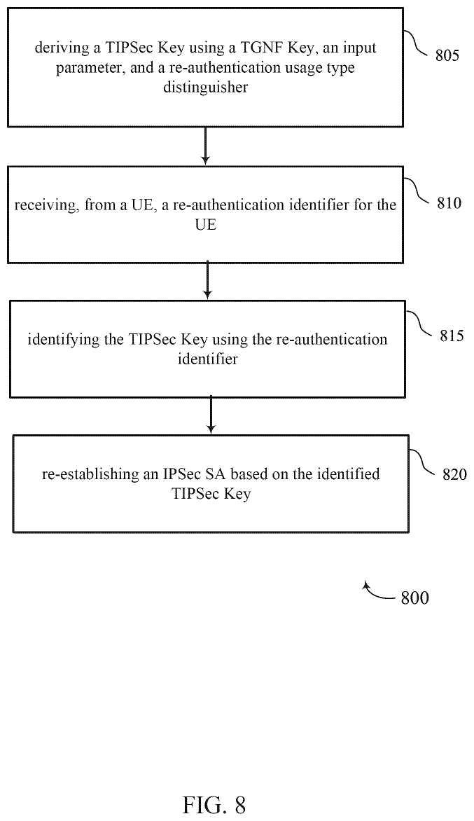

FIG. 8 illustrates a flowchart of a method 800 that supports establishing an IPSec Security Association between a UE and a TNGF in accordance with aspects of the present disclosure. The operations of the method 800 may be implemented by a device or its components as described herein. For example, the operations of the method 800 may be performed by the network entity 102 (e.g., aTNGF) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 805, the method may include deriving a TIPSec Key using a TNGF Key, an input parameter, and a re-authentication usage type distinguisher. The operations of 805 may be performed in accordance with examples as described herein. In some implementations, aspects of the operations of 805 may be performed by a device as described with reference to FIG. 1.

At 810, the method may include receiving, from a UE, a re-authentication identifier for the UE. The operations of 810 may be performed in accordance with examples as described herein. In some implementations, aspects of the operations of 810 may be performed by a device as described with reference to FIG. 1.

At 815, the method may include identifying the TIPSec Key using the re-authentication identifier. The operations of 815 may be performed in accordance with examples as described herein. In some implementations, aspects of the operations of 815 may be performed by a device as described with reference to FIG. 1.

At 820, the method may include re-establishing an IPSec SA based on the identified TIPSec Key. The operations of 820 may be performed in accordance with examples as described herein. In some implementations, aspects of the operations of 820 may be performed by a device as described with reference to FIG. 1.

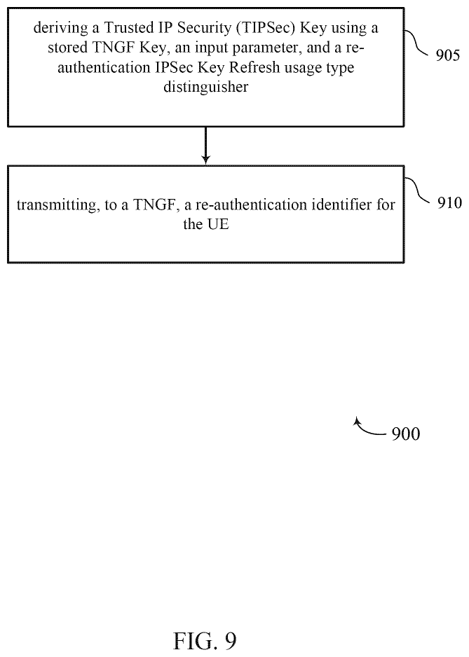

FIG. 9 illustrates a flowchart of a method 900 that supports authentication of a UE to a TNGF in accordance with aspects of the present disclosure. The operations of the method 900 may be implemented by a device or its components as described herein. For example, the operations of the method 900 may be performed by the UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 905, the method may include deriving a Trusted IP Security (TIPSec) Key using a stored TNGF Key, an input parameter, and a re-authentication IPSec Key Refresh usage type distinguisher. The operations of 905 may be performed in accordance with examples as described herein. In some implementations, aspects of the operations of 905 may be performed by a device as described with reference to FIG. 1.

At 910, the method may include transmitting, to a TNGF, a re-authentication identifier for the UE. The operations of 910 may be performed in accordance with examples as described herein. In some implementations, aspects of the operations of 910 may be performed by a device as described with reference to FIG. 1.

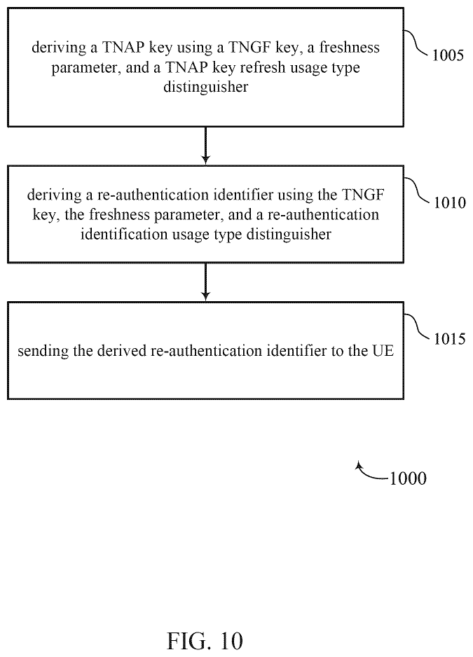

FIG. 10 illustrates a flowchart of a method 1000 that supports generating a security context between a UE and a TNAP in accordance with aspects of the present disclosure. The operations of the method 1000 may be implemented by a device or its components as described herein. For example, the operations of the method 1000 may be performed by the network entity 102 (e.g., aTNGF) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1005, the method may include deriving a TNAP key using a TNGF key, a freshness parameter, and a TNAP key refresh usage type distinguisher. The operations of 1005 may be performed in accordance with examples as described herein. In some implementations, aspects of the operations of 1005 may be performed by a device as described with reference to FIG. 1.

At 1010, the method may include deriving a re-authentication identifier using the TNGF key, the freshness parameter, and a re-authentication identification usage type distinguisher. The operations of 1010 may be performed in accordance with examples as described herein. In some implementations, aspects of the operations of 1010 may be performed by a device as described with reference to FIG. 1.

At 1015, the method may include sending the derived re-authentication identifier to the UE. The operations of 1015 may be performed in accordance with examples as described herein. In some implementations, aspects of the operations of 1015 may be performed by a device as described with reference to FIG. 1.

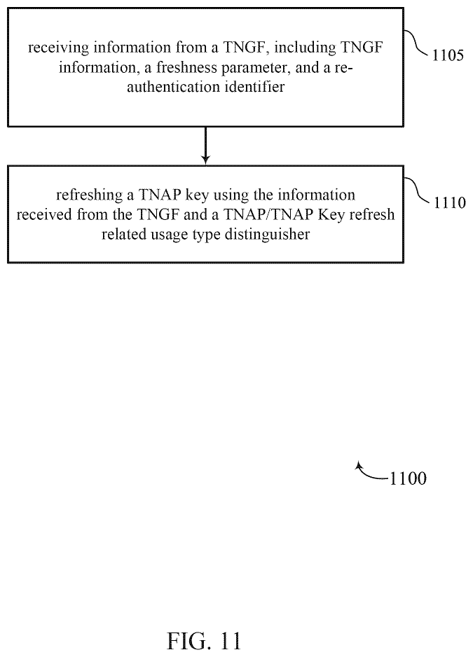

FIG. 11 illustrates a flowchart of a method 1100 that supports generating a security context for a UE in accordance with aspects of the present disclosure. The operations of the method 1100 may be implemented by a device or its components as described herein. For example, the operations of the method 1100 may be performed by the UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1105, the method may include receiving information from a TNGF, including TNGF information, a freshness parameter, and a re-authentication identifier. The operations of 1105 may be performed in accordance with examples as described herein. In some implementations, aspects of the operations of 1105 may be performed by a device as described with reference to FIG. 1.

At 1110, the method may include refreshing a TNAP key using the information received from the TNGF and a TNAP/TNAP Key refresh related usage type distinguisher. The operations of 1110 may be performed in accordance with examples as described herein. In some implementations, aspects of the operations of 1110 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A Trusted Non-3GPP Gateway Function (TNGF) for wireless communication, comprising:
at least one memory; and
at least one processor coupled with the at least one memory and configured to cause the TNGF to:
generate a security context between user equipment (UE) and a Trusted Non-3GPP Access Point (TNAP), by:
deriving a TNAP key using:
a TNGF key,
a freshness parameter, and
a TNAP key refresh usage type distinguisher.

2. The TNGF of claim 1, wherein the processor is configured to cause the TNGF to derive the TNAP key using the TNGF key and one or more input parameters, including: re-authentication TNAP Key Refresh related usage type information, a length of a re-authentication TNAP Key Refresh usage type distinguisher, a TNGF Nonce, and a length of the TNGF Nonce.

3. The TNGF of claim 1, wherein the processor is configured to cause the TNGF to generate the security context between the UE and the TNAP by deriving a Trusted IP Security (TIPSec) Key.

4. The TNGF of claim 3, wherein the processor is configured to cause the TNGF to derive the TIPSec Key using the TNGF key and one or more input parameters, including: re-authentication IPSec/IPSec Key refresh related usage type information, a length of a re-authentication IPSec/IPSec Key refresh usage type distinguisher, a TNGF Nonce, a length of the TNGF Nonce, a UE Nonce, and a length of the UE Nonce.

5. The TNGF of claim 1, wherein the processor is configured to cause the TNGF to derive a re-authentication identifier using the TNGF key and one or more input parameters, including: re-authentication identification/identifier related usage type information, a length of a re-authentication identification/identifier usage type distinguisher, a TNGF Nonce, a length of the TNGF Nonce, a UE Nonce, and a length of the UE Nonce.

6. The TNGF of claim 1, wherein the processor is configured to cause the TNGF to store a derived re-authentication identifier with the derived TNAP key and the TNGF key.

7. The TNGF of claim 1, wherein the processor is configured to cause the TNGF to establish over-the-air security between the UE and the TNAP using the derived TNAP key.

8. The TNGF of claim 1, wherein the processor is configured to cause the TNGF to generate the security context in response to UE mobility from a different TNAP to the TNAP for which the security context is generated by the TNGF.

9. The TNGF of claim 1, wherein the freshness parameter includes a TNGF Nonce, a length of the TNGF Nonce, a UE Nonce, a length of the UE Nonce, a counter, a length of a counter, a random number, or a length of a random number.

10. A method performed by a Trusted Non-3GPP Gateway Function (TNGF) for generating a security context between user equipment (UE) and a Trusted Non-3GPP Access Point (TNAP), the method comprising:
deriving a TNAP key using a TNGF key, a freshness parameter, and a TNAP key refresh usage type distinguisher.

11. The method of claim 10, further comprising:
deriving a Trusted IP Security (TIPSec) Key.

12. The method of claim 10, further comprising:
storing a derived re-authentication identifier with the derived TNAP key and the TNGF key.

13. (canceled)

14. The method of claim 10, further comprising:
establishing over-the-air security between the UE and the TNAP using the derived TNAP key.

15. A user equipment (UE) for wireless communication, comprising:
at least one memory; and
at least one processor coupled with the at least one memory and configured to cause the UE to:
receive information from a Trusted Non-3GPP Gateway Function (TNGF), including:
TNGF information;
and
refresh a TNAP key using the information received from the TNGF and a Trusted Non-3GPP Access Point (TNAP)/TNAP Key refresh related usage type distinguisher.

16. The UE of claim 15, wherein a freshness parameter includes a TNGF Nonce, a length of the TNGF Nonce, a UE Nonce, a length of the UE Nonce, a counter, a length of a counter, a random number, or a length of a random number.

17. The UE of claim 15, wherein the UE establishes a security context with a TNAP associated with the TNGF using the refreshed TNAP key.

18. A processor for wireless communication, comprising:
at least one controller coupled with at least one memory and configured to cause the processor to:
receive information from a Trusted Non-3GPP Gateway Function (TNGF), including:
TNGF information;
and
refresh a TNAP key using the information received from the TNGF and a Trusted Non-3GPP Access Point (TNAP)/TNAP Key refresh related usage type distinguisher.

19. The processor of claim 18, wherein a freshness parameter includes a TNGF Nonce, a length of the TNGF Nonce, a user equipment (UE) Nonce, a length of the UE Nonce, a counter, a length of a counter, a random number, or a length of a random number.

20. The processor of claim 18, wherein the processor establishes a security context with a TNAP associated with the TNGF using the refreshed TNAP key.

21. The TNGF of claim 1, wherein the at least one processor is configured to cause the TNGF to generate a security context by:
deriving a re-authentication identifier using:
the TNGF key,
the freshness parameter, and
a re-authentication identification usage type distinguisher; and
sending the derived re-authentication identifier to the UE.
